(19) United States
(12) Patent Application Publication
(10) Pub. No.: US 2018/0169943 A1
(43) Pub. Date: Jun. 21, 2018

(54) Rapid Prototyping/Manufacturing-Construction Platform as well as Rapid Prototyping/Manufacturing Process

(71) Applicant: Ivoclar Vivadent AG, Schaan (LI)

(72) Inventors: Rudolf Jussel, Feldkirch (AT); Walter Pokomy, Bludesch (AT); Fabio Gfeller, Sevelen (CH)

(21) Appl. No.: 15/836,172

(22) Filed: Dec. 8, 2017

(30) Foreign Application Priority Data
Dec. 19, 2016 (EP) 16 205 158.5

(51) Int. Cl. B29C 64/245; A61C 13/00; B29C 64/141; B29C 64/188; B29C 64/393

(52) U.S. Cl. CPC B29C 64/245; A61C 13/0004; B33Y 10/00; B29C 64/188; B29C 64/393; B29C 64/141

(57) ABSTRACT

A rapid prototyping/manufacturing construction platform (100) as a base for the creation of a plurality of components (20, 40) through a rapid prototyping/manufacturing process. The construction platform (100) includes a carrier substrate (4) for carrying the components (20, 40) to be manufactured, to which a three-dimensional structure is incorporated or applied. The three-dimensional structure comprises individual structures (12, 14, 16) for each component (20, 40) to be manufactured or for each group of components (20, 40) to be manufactured, which individual structures (12, 14, 16) are different among each other.

### CROSS-REFERENCE TO RELATED APPLICATIONS

This application claims priority to European patent application No. 16205158.5 filed on Dec. 19, 2016, the disclosure of which is incorporated herein by reference in its entirety.

### FIELD OF THE INVENTION

The invention relates to a rapid prototyping/manufacturing construction platform as well as a rapid prototyping/manufacturing process.

### BACKGROUND OF THE INVENTION

In a rapid prototyping/manufacturing process, a digital 3D model of a component to be created is initially generated with an appropriate CAD system. The digital 3D model is then supplied to a control device of a CAM device and is analyzed therewith. Based on the analysis result, the control device subsequently controls the CAM device to perform a construction job, wherein a component is created, and is especially created in layers.

In the construction job, a construction platform is used, which serves as a base for the creation of the component. Following the construction job, a removal process is to be performed, wherein the component is removed from the construction platform, especially by mechanical and/or chemical separation technology. In a stereolithography process additional supporting structures may be made use of, which are connected to the construction platform and, during the construction job, serving for retaining the component, among others, against the lateral pressure of a coating knife during horizontal movement of the coating knife across the as-polymerized layer, to refill the space above this layer with light-curing plastics as a construction material. In the removal process, the supporting structures are also to be separated from the component created.

Following the removal process, the component is cleaned and is completely cured, for example in a light-curing apparatus or oven.

It is not before this that a manufactured component may be packed and shipped to the end user.

In order to save production time in mass production of the components, cooperative rapid prototyping/manufacturing processes have been developed, wherein, in one construction job, several components are constructed at a mutually shared construction platform. If the number of the components to be manufactured in one construction job is relatively large or construction jobs are required to be successively performed within a relatively short period of time, following removal and eventually following successive post-treatment, such as e.g. cleaning and/or curing, it often happens that the user does not know any more, which order number is assigned to a manufactured component. This is the case, the more the components differ only slightly from each other and in an extend that is difficult to be distinguished by an employee. This is especially true with dental structures or restorations, respectively.

In order to overcome this situation, the components have long been labelled, for example with color marker pens, stickers or Post-It notes during or prior to removal. Accordingly, in the CAD system, which is useful for the rapid prototyping/manufacturing process, the components as well require virtual labelling.

However, manual labelling is time consuming and, with almost identical components and/or in less careful labelling, is not reliable. The information attached might get lost after removal of the components and, for example, might get lost during cleaning. In part, no reasonable room is available for directly labelling onto the component or this is not desirable. This is especially true if all surfaces are functional surfaces.

In a known solution, it is provided that a 2D or 3D barcode in the form of e.g. Quick Response Codes (QR Codes) is created thereon for identification of a dental restoration part to be fabricated by a stereolithography process, and is attached to the dental restoration part. The dental restoration part is identified by scanning the barcode with a CCD camera or a CCD scanner. However, since the barcode is always arranged on or adjacent to the dental restoration part, attachment of supporting structures to the dental restoration part, which is required in the stereolithography process, is limited. Instead, the area of the dental restoration part that is to be connected to the supporting structures for retention is required to be connected to the barcode element for identification and therefore is not stable. Moreover, an additional step is required to be performed, to separate the dental restoration part from the barcode. In addition, for each dental restoration part to be manufactured, a non-small barcode element must be co-created, resulting in significant expense in construction material. For good readability and attachment of sufficient information, such as for example assignment of a customer order number and position of the barcode must be formed appropriately large.

The document DE 10 2012 011 217 A1 discloses recesses containing plate-like object holders for accommodating components to be manufactured by way of rapid prototyping/manufacturing processes, consisting of an object bottom part and top part. The object holders are fixed on a support plate, and the recesses of the object holder differ in their geometry. In this way, labelling is possible. However, prior to the construction job, the object's bottom parts are required to be pre-fabricated according to the form of the recesses and subsequently be attached to each one of the recesses in an manner known per se; moreover, for removal of each component, a predetermined breaking point must be provided at each object bottom part. This is significantly more complicated in comparison to a general rapid prototyping/manufacturing process. Moreover, with this approach, the size of the components created is limited to the size of the recesses thereof. A component to be created, the horizontal cross-section of which has a relatively large surface area, which, for example, is three times that of the recess, cannot be manufactured with this solution.

### SUMMARY

On the other hand, it is the object of the invention to provide a rapid prototyping/manufacturing construction platform as a base for the creation of a plurality of components, as well as a rapid prototyping/manufacturing process for the creation of a plurality of components, which, at least partially, remedies the drawbacks named above.

According to the invention, this object will be solved according to the independent claims. Advantageous embodiments will arise from the subclaims.

According to the invention, the bottom or the base of a component is commercially made use of for the first time. A three-dimensional structure is incorporated or attached to a carrier substrate of the construction platform according to the invention, which is for carrying the components to be manufactured, and facing the component base or the component bottom, respectively. The three-dimensional structure has individual structures for each component to be manufactured or for each group of components to be manufactured, which individual structures are different among each other.

With the three-dimensional structure, which is formed of the different individual structures, thereby comprising a graphical and site-specific structure, in a rapid prototyping/manufacturing process, especially a stereolithography process, a respective mirrored structure is deposited on the first layers and at the bottom of the components to be manufactured, especially the dental restoration parts, respectively.

According to the invention, it is assured that those mirrored structures have different forms, since in a construction job—and also in some construction jobs performed successively—the manufactured components are build-up at different sites of the construction platform according to the invention, at which sites, due to the arrangement of different individual structures, different graphics or cut ends are provided.

In this way, according to the invention, with the information relating the manufacture site, each one component is distinctly labelled on its bottom. In the appropriate CAD system, a virtual construction platform will be designed corresponding to the construction platform according to the invention. In this way, the above-mentioned manufacturing site of the component at the construction platform according to the invention is to be assigned to the respective virtual site at the virtual construction platform, which virtual site corresponds to the respective work order, especially patients.

The three-dimensional structure at the carrier substrate of the construction platform according to the invention may be produced by generative or subtractive, especially abrasive processes, such as engraving, electro-erosion, milling. Among those generative processes are, among others, the rapid prototyping/manufacturing process.

With the construction platform according to the invention, each time prior to a construction job, time and material-consuming attachment of e.g. barcode elements or labelling media may be avoided. Moreover, assignment to the respective order number of the components created through the construction platform according to the invention is more reliable. According to the invention, defective labeling and/or labeling having been lost, e.g. during cleaning, will be avoided.

It is especially of advantage that for similar or almost identical components to be manufactured, the assignment permitted by the present invention is significantly more reliable. Because assignment is not any more realized by the shape of the components, but the manufacturing site of the components at the construction platform, i.e. by the shape at the component base.

It is surprising that, according to the present invention, the size of a component base—and also the size of a component—is not limited by the horizontal cross section of an individual single structure of the three-dimensional structure according to the invention.

In the construction process of the present rapid prototyping/manufacturing process, especially of the stereolithography process, initially, with the help of a CAM device, the three-dimensional structure will be covered or filled with construction material at the carrier substrate of the construction platform according to the invention. By subsequent irradiation of the construction material, the first layers of the component base become apparent, at which component base part of the three-dimensional structure will be transferred in a mirrored way. At the component base, only part of an individual structure or a complete individual structure or of a combination of (parts of) individual structures of the three-dimensional structure according to the invention may be mirrored “copied” or transferred, respectively.

By continuing the construction jobs, the component then will be build-up layer-wise and completely.

In a preferred embodiment, it is provided that the carrier substrate of the construction platform according to the invention is covered with the individual structures, which comprise recesses and/or elevations. The recesses and elevations may adjacently be arranged and may have different forms. The depth of the recesses or the height of the elevations is 0.02 mm to 2 mm, respectively. In the construction process, a mirrored structure is initially built up by filling the recesses or covering the elevations at the bottom side of the component.

If the depth of the recesses of the individual structures at the carrier substrate of the construction platform according to the invention is relatively large and is e.g. approximately 1 mm, especially in the stereolithography process during formation of the first layers of the component base, the construction material thereof, such as e.g. light-curing plastics, dissolved in the bath of the process, is required to be irradiated for a long time, for example up to several minutes. In this way, the above-mentioned first layers including the construction material in the recesses below the first layers may completely be cured.

Eventually, it may also be of advantage to increase adhesion of a first layer or several layers to a construction platform or a carrier substrate attached thereto, by way of the incorporated or applied structure, respectively, by way of an enlarged surface area.

If the components are dental restoration parts, especially supra-constructions, the base of a dental restoration part may serve as an adhesive surface at a prosthesis base or an abutment. According to the invention, it is especially advantageous that the recesses, corresponding to the elevations of the construction platform according to the invention at the base of the dental restoration part of the individual structures enlarge the entire adhesive surface. In this way, connection between the dental restoration part and the prosthesis basis or the abutment, especially in the gingival area, will be improved.

In this case, the adhesive gap between the base of the dental restoration part and the prosthesis base or the abutment, respectively, generally is approximately 150 μm. In order for any elevation at the base of the dental restoration not to exceed 150 μm and not affect bonding, the depth of the respective recesses of the individual structures of the construction platform according to the invention should be dimensioned to less than 100 μm, especially less than 50 μm.

In another preferred embodiment, it is provided that each individual structure is constructed according to a similar geometrical system; i.e. for example, it is constructed in the form of numbers, codes or geometrical forms. For example, each one of ten manufactured dental restoration parts, corresponding to ten order numbers, may centrally be built-up onto one individual structure of the construction platform according to the invention with numbers from 1 to 10 or letters running from A to J. The surface area of the horizontal cross section of the individual structures is preferably 10% to 80% of the base surface of the dental restoration parts. Following removal and eventually post-treatments of the dental restoration parts assignment then is reasonably simple: The dental restoration part having the number “1”, or the letter “A” at the bottom thereof corresponds to the first work order; the dental restoration part having the number “2”, or the letter “B” at the bottom thereof corresponds to the second work order and so on.

In another preferred embodiment, it is preferred that the individual structures are for filling or covering a component base, respectively, which component basis, especially in a stereolithography process, is each connected via supporting structures to the associated component, especially a dental restoration part.

In this embodiment, for assignment of the component, the component base is provided with the mirrored single structure(s). The component base is connected to the associated component via supporting structures until delivery to the end user. Thereafter, upon insertion, for example in a patient, the supporting structures may be discarded or may even be reused. Depending on the embodiment, the supporting structures may also be made use of for safely shipping or storing the component itself.

In another preferred embodiment, it is provided that the individual structures comprise elevations at the carrier substrate that are formed adjacent to recesses. An individual structure may consist of a combination of elevations and recesses, or may consist solely of elevations, or solely of recesses. Edges, especially diverting from each other, extend from the recesses to the elevations, to facilitate removal of the components from the construction platform according to the invention, following the construction job.

In another preferred embodiment, it is provided that the construction platform comprises a removable and replaceable carrier substrate. Each one of the carrier substrates is provided with different three-dimensional structures for the creation of differently formed component bases.

Removability and interchangeability of the carrier substrate of the construction platform according to the invention allows for significant faster provision of components, especially in mass production. It is widely recognized that, following a construction process, components are required to be removed from a construction platform, which finally needs to be cleaned for removal of residual construction materials in the form of e.g. liquids or powders, which, depending on the material, may be arduous and time-consuming. It is not before a drying routine that the construction platform is again ready-to-use. In some cases, the time from usage until re-usage of the construction platform even amounts to hours.

According to the invention, this period is significantly reduced by replacing the carrier substrate, and the removal process as well as the other post-treatments are to be performed parallel to the construction process for the next construction job. Following a construction process, the carrier substrate of the construction platform that has been used, including the components placed and fabricated thereon, will immediately be removed and will be replaced by another carrier substrate, which should be provided for the next construction job.

In another preferred embodiment, it is provided that the individual structures differing from each other additionally have a feature equal among each other, such as a company logo. In this way, at the bottom of each component the company logo is provided.

In another preferred embodiment, it is provided that the rapid prototyping/manufacturing construction platform, especially the portion thereof at the carrier substrate, consists of deformable material.

Following the construction process, generally a tool, such as an ejector, is used for the removal of components from the construction platform. Moreover, for the removal a certain period of time is required.

With the deformable, especially resilient construction platform, the manufactured components e.g. may fall out, while elastically or plastically deforming the construction platform, especially by way of bending off and/or twisting the construction platform, and thus may easily be removed. This is done tool-less and within a short period of time.

In another preferred embodiment, it is provided that the mirrored structure—also called negative image (elevation) or positive image (recess), respectively—at the component base is detected by an image acquisition device and is analyzed by a control device. Following analyzing result, the control device assigns the component to the appropriate word order. Especially, upon realization of the component as a dental restoration part, the control device performs patient-specific assignment.

Thereafter, the process parameter or the construction job data, (date, equipment, user, etc.), respectively, may be assigned to the component or the work order for quality control purposes.

In another preferred embodiment, it is provided that the rapid prototyping/manufacturing process according to the invention is part of a manufacturing process via CAD/CAM. In the context of a manufacturing process, a virtual model of the component is firstly created and assignment between the model and the form of the single structure(s) is generated.

Following this, the component is built in a rapid prototyping/manufacturing process, especially the stereolithography process, at the construction platform. In a digital workflow in relation to the respective work order, information concerning the component base having the negative image or the positive image of the single structure(s), respectively, remain at the component for further component tracking until delivery to the end user.

### BRIEF DESCRIPTION OF THE DRAWINGS

Further advantages, details and features will arise from the following description of a working example of the invention by way of the figures, wherein:

FIG. 1 shows a schematically represented embodiment of the Rapid-prototyping/manufacturing construction platform according to the invention; and

FIG. 2 shows a bottom view of two components manufactured by the rapid prototyping/manufacturing construction platform according to the invention and the rapid prototyping/manufacturing process according to the invention.

### DETAILED DESCRIPTION

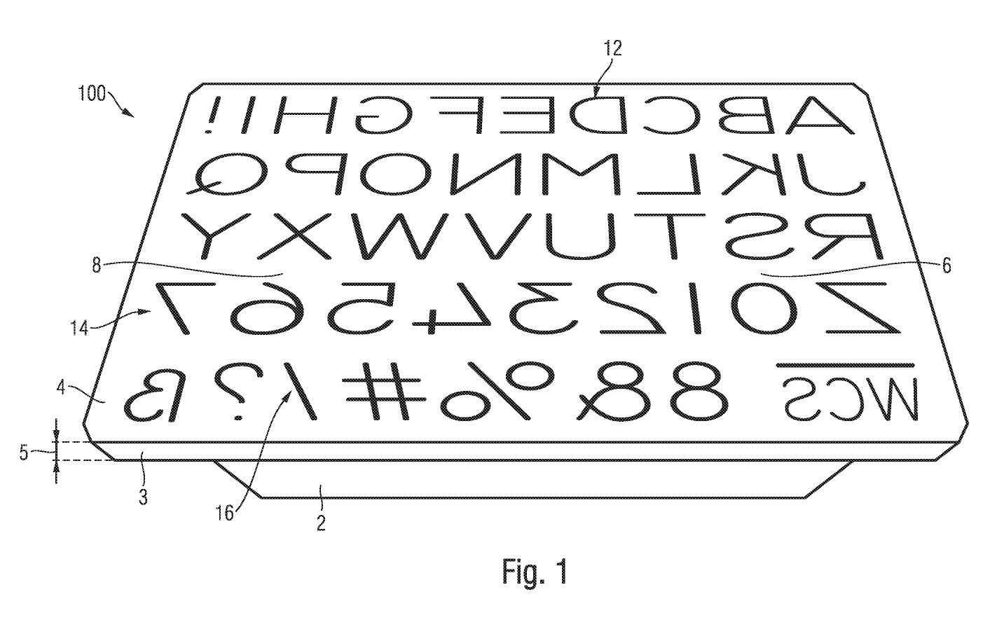

The rapid prototyping/manufacturing construction platform 100 according to the invention schematically represented in FIG. 1 comprises a construction platform holder 2, supporting a form 3 as a base for creating a plurality of components. The thickness 5 of the form 3 is at least 10 mm, especially at least 30 mm.

At the carrier substrate 4 of the construction platform 100 according to the invention individual structures 12, 14, 16 are provided, which as whole form a three-dimensional structure and according to the embodiment represented, are formed in the form of the mirrored letters from A to Z, the mirrored figures from 1 to 8 and the mirrored special characters “?”, “\”, “#” and so on.

In the embodiment represented, the individual structures 12, 14, 16 comprise recesses and elevations—not to be seen in FIG. 1—which, at the carrier substrate 4, are manufactured by a generative and subtractive process in a manner known per se. The depth of the recesses or the height of the elevations is 0.02 mm to 2 mm.

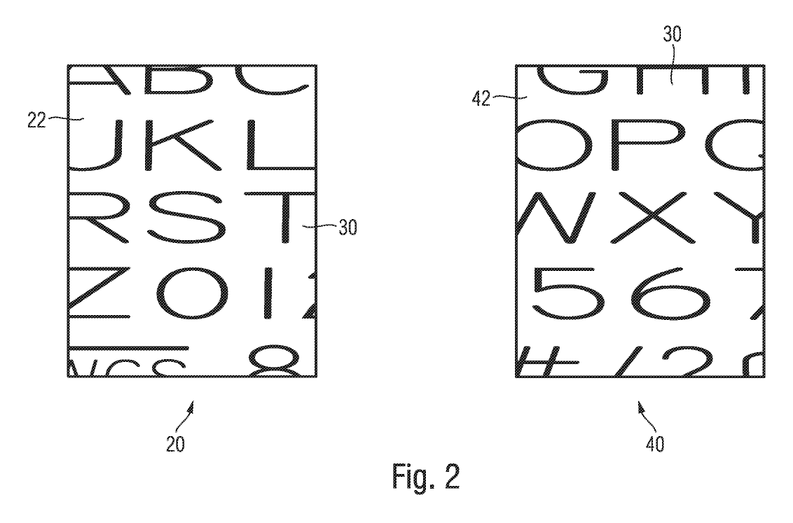

In the construction process, the recesses will be filled with construction material, the elevations will be covered, and thus, the first layers of the components 20, 40 will form as bases of the components 20, 40. At the side 30 facing the construction platform 100 of the respective component bases, a negative image or a positive image 22, 42 of the three-dimensional support structure of the construction platform 100 will be formed, respectively (cf. FIG. 2).

As it is shown in FIGS. 1 and 2, each of the negative images or positive images 22 and 42, respectively, at the bases of the components 20 and 40 correspond to the regions 6 and 8 at the carrier substrate 4 of the construction platform 100 according to the invention.

In this way, with the different forms of the negative images or the positive images 22 and 42, respectively, the fabricated components 20 and 40 each are clearly to be associated to the appropriate sites at the construction platform 100 according to the invention, which sites, in the appropriate CAD system, are each unequivocally connected to the associated work orders, especially patients, in the case of the components being dental restoration parts.

The information relating the component base having the negative image or the positive image 22 and 42, respectively, may remain in a digital workflow for further component tracking, until delivery to an end user.

According to the invention, in this way, assignment of the manufactured components to the work orders, in relation to prior art, is easier more time-saving and more reliable.

According to the embodiment represented, a plurality of elevations of the single structures is formed adjacent to recesses and diverge from edges extending from the recesses to the elevations, so that accordingly, at the component base created, the negative image or the positive image 22, 42, respectively, comprises elevations, recesses and edges, which edges, at the component base, converge from the recesses to the elevations. In this way, removal of the components 20, 40 from the construction platform 100 according to the invention will be facilitated subsequently to the construction job.

The carrier substrate 4 of the construction platform 100 according to the invention is removable and replaceable, thus realizing significantly faster production of components, especially in mass production. According to invention, the removal process performed subsequently to the construction process, as well as further post-treatments may be performed parallel to the construction process for the next construction job. Following a construction process, the carrier substrate 4 employed of the construction platform 100, including the fabricated components 20, 40 placed thereon will be removed and replaced by another carrier substrate 4, which should be provided for the next construction job.

The construction platform 100 according to the invention, especially its shape 3, according to the embodiment represented in FIG. 1, consists of deformable especially resilient material, which, among others, simplifies the removal process.

In an embodiment not represented, it is provided that at the base of a component, especially of a small component, solely one individual structure 12, 14, 16 or solely part of an individual structure 12, 14, 16 is transferred. However, this does not affect exactness of the assignment, as long as the negative image or the positive image 22 and 42, respectively, may applicably identify its associated site at the carrier substrate of the construction platform 100 according to the invention or may solely identify a candidate in the appropriate CAD system.

In another embodiment not represented, the individual structures 12, 14, 16, in the form of patterns and/or symbols and/or lines and/or geometric forms and/or graphics and/or coordinate systems and/or RFID functional chains and/or barcodes and/or Quick-Response codes and/or other codes, may also be provided for identification.

In another embodiment not represented, it is provided that the individual structures 12, 14, 16 different among each other, additionally comprise a company logo. In this way, the company logo is provided for advertising purposes on the bottom of each component 20, 40 manufactured.

1. A rapid prototyping/manufacturing construction platform (100) as a base for the creation of a plurality of components (20, 40) through a rapid prototyping/manufacturing process comprising
a surface or carrier substrate (4) attached to the construction platform for carrying the components (20, 40) to be manufactured,
a three-dimensional structure incorporated or attached to the surface or carrier substrate,
wherein the three-dimensional structure comprises individual structures (12, 14, 16) for each component (20, 40) to be manufactured or for each group of components (20, 40) to be manufactured,
wherein the individual structures (12, 14, 16) are different from each other.

2. The rapid prototyping/manufacturing construction platform according to claim 1,
wherein the plurality of components (20, 40) comprise dental restoration parts and
wherein the rapid prototyping/manufacturing process comprises a stereolithography process.

3. The rapid prototyping/manufacturing construction platform according to claim 1,
wherein the carrier substrate (4) of the construction platform (100) is covered with the individual structures (12, 14, 16),
wherein the individual structures (12, 14, 16) comprise recesses and/or elevations, the depth or height of the recesses and/or elevations being 0.02 mm to 2 mm.

4. The rapid prototyping/manufacturing construction platform according to claim 1,
wherein each individual structure (12, 14, 16) is constructed according to a similar geometrical system.

5. The rapid prototyping/manufacturing construction platform according to claim 4,
wherein the geometrical system comprises numbers, codes or geometrical forms.

6. The rapid prototyping/manufacturing construction platform according to claim 1,
wherein the individual structures (12, 14, 16) are for filling or covering a component base, which component base is connected via supporting structures to each associated component (20, 40)
wherein each component comprises a dental restoration part.

7. The rapid prototyping/manufacturing construction platform according to claim 1,
wherein the three-dimensional structure in the construction platform (100) at the carrier substrate (4) is manufactured by generative or subtractive processes.

8. The rapid prototyping/manufacturing construction platform according to claim 7,
wherein the generative or subtractive processes comprise abrasive processes selected from at least one of engraving, electro-erosion, and milling.

9. The rapid prototyping/manufacturing construction platform according to claim 1,
wherein the individual structures (12, 14, 16) comprise elevations at the carrier substrate that are formed adjacent to recesses, wherein edges extending from the recesses to the elevations diverge from each other.

10. The rapid prototyping/manufacturing construction platform according to claim 1,
wherein the construction platform (100) comprises removable and replaceable carrier substrates (4),
wherein each one of the carrier substrates (4) is designed with different three-dimensional structures for the creation of differently formed component bases.

11. The rapid prototyping/manufacturing construction platform according to claim 1,
wherein the individual structures (12, 14, 16) that are different among each individual structure also comprise a feature equal among each individual structure.

12. The rapid prototyping/manufacturing construction platform according to claim 11,
wherein the feature equal among each individual structure comprises a company logo.

13. The rapid prototyping/manufacturing construction platform according to claim 1,
wherein the rapid prototyping/manufacturing construction platform (100) comprises elastically or plastically deformable disposable or reusable material.

14. A rapid prototyping/manufacturing process for the creation of a plurality of components (20, 40), which starts from a construction platform (100) as a base for the assembly of the components (20, 40),
wherein the construction platform (100) comprises a carrier substrate (4) for carrying the components (20, 40) to be manufactured, to which a three-dimensional structure is incorporated or attached that forms individual structures (12, 14, 16) for each component (20, 40) to be manufactured or for each group of components (20, 40) to be manufactured, which individual structures (12, 14, 16) are different among each individual structure,
said process comprising creating the components (20, 40) or groups of components (20, 40) from the individual structures (12, 14, 16) by molding and transferring the three-dimensional structure of the construction platform (100) to a base of the component.

15. The process according to claim 14,
wherein the process comprises a stereolithography process and the plurality of components (20, 40) comprise dental restoration parts.

16. The process according to claim 14,
further comprising removing the components (20, 40) from the construction platform (100) together with the component base,
wherein a side (30) of the component base facing the construction platform (100) forms a negative image and/or a positive image (22, 42) of the three-dimensional supporting structure of the construction platform (100) to identify the component (20, 40) or the groups of components (20, 40).

17. The process according to claim 14,
further comprising following construction of the component (20, 40), releasing said component, together with the component base, off or from the individual structure (12, 14, 16) of the carrier substrate (4) of the construction platform (100) and
identifying by shape of the component base the component.

18. The process according to claim 14,
further comprising acquiring by an image acquisition device at the component base the negative image and/or positive image (22, 42), and
analyzing the negative image and/or positive image (22, 42) by a control device, wherein the control device performs assignment to the associated patients, upon realization of the component (20, 40) as a dental restoration part.

19. The process according to claim 14,
wherein the process is part of a manufacturing process via CAD/CAM,
wherein a virtual model of the component (20, 40) is initially created and assignment between the model and a form of the individual structure (12, 14, 16) is created, such that the component (20, 40) is subsequently constructed in a stereolithography process at the construction platform (100) and in that the component base, with the negative image and/or positive image (22, 42) of the individual structure (12, 14, 16), subsequently remains on the component (20, 40) for further component tracking in a digital workflow until delivery to an end user.
